(19) United States
(12) Patent Application Publication
(10) Pub. No.: US 2011/0194200 A1
(43) Pub. Date: Aug. 11, 2011

(54) REARVIEW MIRROR

(76) Inventor: Laura Greenlee, San Diego, CA (US)

(21) Appl. No.: 12/917,732

(22) Filed: Nov. 2, 2010

Related U.S. Application Data
(60) Provisional application No. 61/280,315, filed on Nov. 2, 2009.

(51) Int. Cl. G02B 5/09; G02B 7/182; F21V 33/00

(52) U.S. Cl. 359/860; 359/871; 359/850; 362/135; 359/872

(57) ABSTRACT

A mirror that provides a rearview reflection is described. The rearview mirror (“RM”) may include a housing and a first mirror. The RM may further include a mounting assembly configured to couple a first portion of the housing to a surface and a securing mechanism to couple the first mirror to a second portion of the housing, where the first mirror is configured to provide a rearview reflection of an individual and/or object positioned in front of a second mirror. The first mirror may be angled. The RM may include one or more lights coupled to the housing. The RM may further include a storage unit. The angle of the first mirror may be controlled manually, mechanically, and/or electronically. The lights may be activated manually, mechanically, and/or electronically.

### CROSS-REFERENCE TO RELATED APPLICATIONS

This application claims priority of U.S. Provisional Patent Application Ser. No. 61/280,315, filed on Nov. 2, 2009, which application is incorporated by reference in this application in its entirety.

### BACKGROUND OF THE INVENTION

This invention relates generally to mirrors and, in particular, to mirrors that provide a rearview reflection.

Personal grooming is an essential part of the way people present themselves to the world. Individuals go to styling salon or the barbershop for periodic, professional grooming services. However, people conduct self-grooming on a daily basis in their homes using grooming tools and accessories.

A mirror is indispensible for proper grooming. Typically, mirrors are fixed or mounted to a wall or part of a unit, such as a vanity, found in a bathroom. These mirrors provide a reflection at a fixed angle, thereby requiring a user to change his or her orientation in order to maximize the amount of reflection. Additionally, these mirrors provide a frontal reflection, which enables a man to shave and a woman to apply her make-up. However, individuals need to see the back of their head or neck, when brushing, styling, and/or applying jewelry and other accessories. For example, a woman styling her hair works blindly, when it comes to the hair on the back of her head.

To see the back of the head, a user will work with a hand mirror and a frontal mirror. This combination is unwieldy and awkward, and leaves only one hand free to perform brushing, styling, drying, or cutting of the hair. The following patents describe mirror devices.

U.S. Pat. No. 2,119,208 to Henry F. Goldsmith describes a compactly folding handheld vanity mirror for viewing the back of the head or headdress and for general personal use.

U.S. Pat. No. 2,874,613 to Earl M. Bogar, Jr. describes a support for tilting mirrors, and more particularly, to a device for connecting a mirror to a dresser, bureau, or other article of furniture to support the mirror above such article for vertical tilting movement.

U.S. Pat. No. 6,315,422 to Justin S. Letlow describes a rear and side view mirror device for allowing one to inspect one's ear for certain build-up of wax and dirt.

None of these patents provides a simple, elegant, and cost-effective solution to provide a user the ability to provide a rearview reflection.

### SUMMARY

A mirror that provides a rearview reflection is described. The rearview mirror (“RM”) may include a housing and a first mirror. The RM may further include mounting assembly configured to couple a first portion of the housing to a surface and a securing mechanism to couple a second portion of the housing to the first mirror, where the first mirror is configured to provide a rearview reflection of an individual and/or object positioned in front of a second mirror. The first minor may be angled. The RM may include one or more lights coupled to the housing. The RM may further include a storage unit. The angle of the first mirror may be controlled manually, mechanically, and/or electronically. The lights may be activated manually, mechanically, and/or electronically.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a front perspective view of the RM in an embodiment.

FIG. 2 is a perspective view of the RM of FIG. 1 including a storage unit and a lighting source in an embodiment.

FIG. 3 is a perspective view of the RM with a double-sided mirror in an embodiment.

FIG. 4 is a perspective view of the RM with a triple-sided mirror in an embodiment.

### DETAILED DESCRIPTION

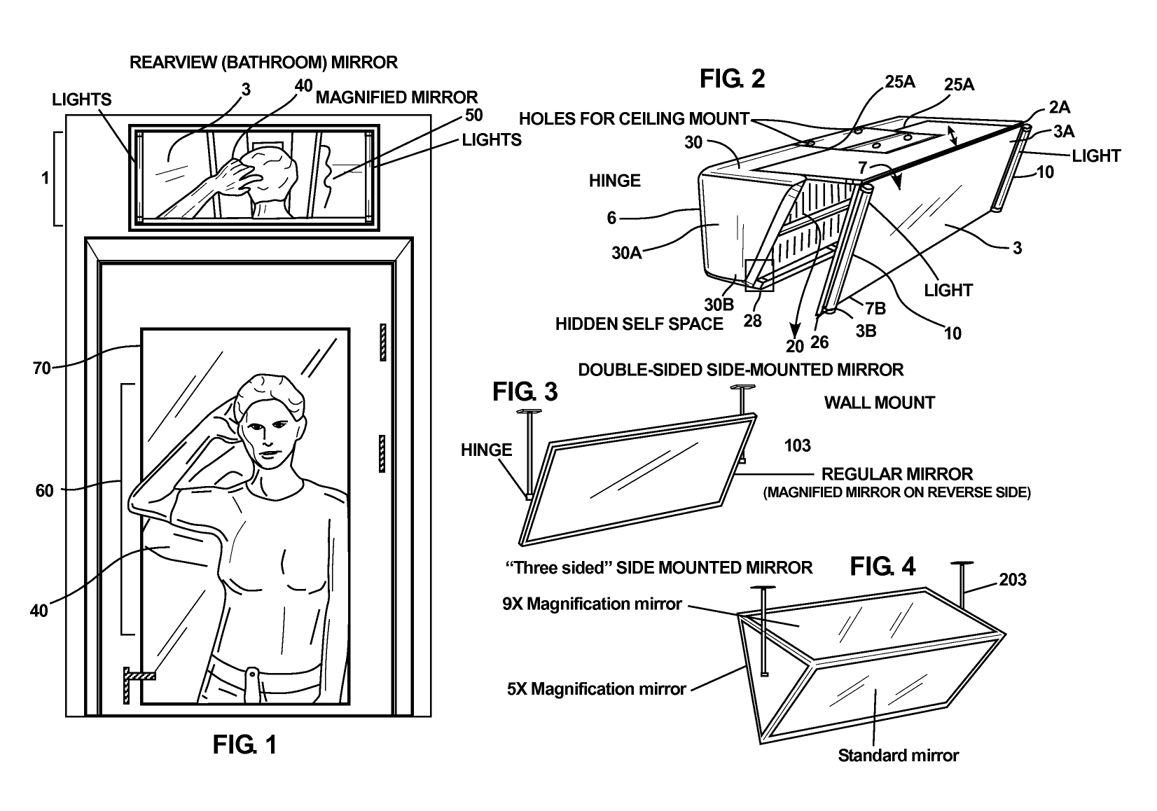

In FIG. 1, a frontal view in an example of the RM 1 is shown. The RM 1 may include a mirror 3. The RM 1 may be mounted to a suitable surface, such as a wall or door. The mirror 3 may be made from any combination of materials that provides a reflection. In one embodiment, the mirror 3 of the RM 1 may be configured or positioned to provide a rearview reflection 50 of an individual and/or object. For example, the mirror 70 provides a frontal reflection 60 of an individual 40, while the RM 1 provides a rearview reflection 50 of the individual 40. The mirror 3 may also include materials that prevent fog or steam to build onto the mirror 3.

The RM 1 may have be made from many shapes, sizes, color, and materials and oriented in any direction depending on several factors, such as the available space, location, and required uses, etc. As shown in the example of FIG. 2, the RM 1 may include a housing 30 with sides 30A, the mirror 3, and mounting assembly 25 to secure the RM 1 to a surface 6. The mirror 3 may be enclosed on one or more sides by a frame 7 made from any material suitable to support the mirror 3. The mounting assembly 25 may include various configurations. For example, the mounting assembly may include mounting holes 25A for receiving a securing or fastening mechanism, such as a bolt or screw assembly, for coupling the RM 1 to a surface located above the housing, such as a ceiling. The mounting holes 25A may also be located behind the storage unit 20 so that the RM 1 may also be mounted to a wall, such as surface 6. The mirror 3 may be generally rectangular and enclosed by frame 7. The mirror 3 may be approximately 12 to 14 inches in height, 36 to 48 inches in length, and oriented horizontally. The mirror 3 may be mounted opposite a mirror 70 and may be mounted obliquely at the junction of a ceiling and a wall, such that the mirror is angled or tilted downward. As shown in FIG. 1, the mirror 3 provides the rearview reflection 50 of the individual 40 and the mirror 10 provides a frontal reflection 60 of the individual 40.

As discussed above, the RM 1 may be mounted or coupled to the housing 30 so that the mirror 3 may be conveniently tilted or angled to accommodate, for example, the height of the user or minimize light reflection from a source, such as mirror 70. The RM 1 may be angled or tilted manually, mechanically, or electronically depending on the configuration. For example, RM 1 may include a motor mechanically and/or electronically coupled to the mirror 3 that is locally or remotely controlled, which can adjust angle of the mirror between several positions. The motor may also be operated using a suitable wireless device including a smartphone, remote control, or similar device. For example, the mirror 3 may be controlled to a switch mounted to a wall or a remote control. In other embodiments, the angle of the mirror may be controlled by a voice activation device, which includes a set of programmed controls that may be activated by the user. For example, the mirror 3 may be adjusted to a first position when the user says “position 1.”

As shown in the example of FIG. 2, the RM 1 may include one or more lights 10, which may be positioned along one or more edges of the mirror 3. The lights 10 may be turned on/off turned on manually by a conventional switch coupled to a power source that is integrated into the RM 1. The power source may be powered by a battery or other suitable device. The lights may also be controlled electronically using a suitable device, such as a switch electrically mounted to a wall or a remote control. The lights may have several brightness settings, which may be controlled by a conventional dimming mechanism coupled to a switch or a wall mounted switch. The brightness of the lights 10 may also be controlled by a voice activation device, which includes a set of programmed brightness levels that may be activated by a user. For example, the lights 10 may be adjusted to a first brightness level when the user says “brightness 1.” The lights 10 may also be controlled by a conventional wireless device, including a smartphone, remote control, or other similar device.

As shown in the example of FIG. 2, the top of the mirror 3A and the bottom of the mirror 3B may extend outward from the surface 6. For example, the top of the mirror 3A may extend approximately 12 to 14 inches from a surface 6 and the bottom of the mirror 3B may extend 4 to 6 inches from the surface 6. The RM 1 may also include a storage unit 20 configured as part of the RIM to store supplies and accessories, such as hair products, brushes, and the like. The size and shape of storage unit 20 may vary depending on the configuration of the RM 1. The RM 1 may also include a flexible material covering the sides of the housing 30, which bends or compresses as the mirror is angled as discussed above and below.

The RM 1 may be mounted to any type of surface 6 suitable to support to the RM 1. In an example, the mounting assembly 25 may include the mounting holes 25A and also additional mounting components, which may be triangular in profile with a vertical member coupled at or near each end of the RM 1 and a horizontal member coupled at or near each end of the RM 1 that extends horizontally outward. The mirror 3 may form the diagonal that completes a triangle-shaped configuration. The mounting assembly 25 may be adjustable to support adjustable mirror-dimensions and to allow mounting on the ceiling, a side wall or a rear wall; or a rotating three-sided mirror.

In one embodiment, the top corners of the mirror 3A and frame 7A may include a hinge or similar assembly that extends in a substantially horizontal direction along at least a portion of the top of the mirror 3A and/or frame 7A to enable the mirror 3 to swing in an upward or downward direction. This allows access to the storage unit 20 and/or allows the mirror 3 to swing in an upward direction so that the face of the mirror 3A is substantially perpendicular with the surface 6, when the mirror 3 is not in use. In an embodiment, the bottom of mirror 3B and/or frame 7B may include a mechanism to secure the mirror to the housing 30. For example, a magnetic strip 26 may be coupled to the bottom of the mirror 3B to couple the mirror 3 to the to a magnet 28 coupled to the bottom of the housing 30B. The mirror 3 may be angled relative to the magnet 28 such that the mirror is sufficiently held in place at various angles. The mirror 3 may also be coupled to the housing by other securing mechanisms, such as Velcro, a hinge, a bolt assembly, or other similar mechanisms.

As shown in the example in FIG. 2, the top corners 3B of the mirror 3 and the top corners 7A of the frame 7 may include a slide and sleeve mechanism, where the top of the mirror 3B is pulled forward, producing a more pronounced downward slant of the mirror's face. The adjustment and positioning of the mirror's face may be performed manually, mechanically, or electronically similar to the way the mirror 3 may be tilted or angled, as discussed above.

The RM 1 may include a wide variety of features and configurations. For example, FIG. 3 shows an example of a double-sided mirror 103 that may be configured for use with RM 1. In this example, the mirror 103 includes a front panel 103A with a first optical magnification and a second panel 103B with a second optical magnification. The mirror 103 may have any amount of optical magnification. For example, the mirror 103 may have an optical magnification of 5 to 9 times that of a standard mirror. The mirror 103 may be coupled in such a way that the mirror 103 may be flipped or rotated to provide a standard mirror on one side and/or a magnifying mirror on the other. In one example, the lights 10 may be coupled to one or more sides of the mirror 103.

FIG. 4 shows an example a three-sided mirror 203 that may be configured for use with RM 1. Like the mirror 103, the three-sided mirror may have sides with different optical magnifications. In addition, the mirror 203 may be rotated in different directions to access the different sides of the mirror 103.

Additional embodiments of the RM 1 include a variety of materials and finishes for the frame 7, including combinations of stainless or brushed steel, copper, brass, nickel, aluminum, chrome, and wood. The storage unit 20 may be formed from wood, metal, or plastic. In addition, the mounting assembly 25 may include a simple wall mount, a pivoting mount, and a double-pendulum mount. The mirror 3 may include straight, frame-enclosed, or open beveled edges, and the reflective surface of the mirror 3 may also be also tinted or polarized for optical clarity.

The RM 1 provides a rearview reflection, when styling, cutting, curling, or dyeing their hair without the inconvenience of holding a mirror. Handheld vanity mirrors or adjustable accessory mirrors are small, require continual adjustment for optimal viewing, require the user to use at least one hand to hold the mirror, and require the user to turn his or her back to the main mirror for a rearview. In contrast, the RM 1 offers a large reflecting mirror that is hands-free and requires no turning around to see the back of an individual.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. An apparatus, comprising:
a housing;
a first mirror; and
mounting assembly configured to couple a first portion of the housing to a surface
a securing mechanism to couple the first mirror to a second portion of the housing,
wherein the mirror is configured to provide a rearview reflection of an individual and/or an object positioned in front of a second mirror.

2. The apparatus of claim 1, wherein the first mirror is configured at an angle.

3. The apparatus of claim 1, wherein the first mirror comprises a double-sided and/or a triple-sided mirror.

4. The apparatus of claim 3, wherein the first mirror is configured to include one or more sides with different optical magnifications.

5. The apparatus of claim 1, wherein the first mirror is configured to be angled at more than one position manually, mechanically, and/or electronically.

6. The apparatus of claim 1 further comprising a light source coupled to the first mirror.

7. The apparatus of claim 6, wherein the light source is configured to be activated mechanically, manually, and/or electronically.

8. The apparatus of claim 1 further comprising a storage unit within the housing.

9. The apparatus of claim 1, wherein the first minor is configured to swing upward and/or downward.

10. The apparatus of claim 1, wherein the assembly first mirror is configured to slide forward and/or backward.

11. The apparatus of claim 6, wherein the light source is configured to be controlled by a remote control and/or wireless device.

12. The apparatus of claim 2, wherein the first minor is configured to be angled by a remote control and/or a wireless device.

13. A method, comprising:
providing a housing including a first minor and a mounting assembly; and
positioning the first mirror at angle relative to a second mirror such that the first mirror provides a rearview reflection of an object and/or an individual positioned in front of the second mirror.

14. The method of claim 14 further comprising sliding the first minor forward and/or backward.

15. The method of claim 14 further comprising sliding the first mirror forward and backward.

16. The method of claim 14 further comprising providing a light source coupled to the first minor.

17. The method of claim 14 further comprising coupling and/or integrating a storage unit with the housing.

18. The method of claim 14 further comprising controlling the angle of the first mirror manually, mechanically, and/or electronically.

19. A system, comprising
a housing including a first mirror; and
a second mirror configured to provide a frontal reflection of an object and/or individual,
wherein the first mirror is configured to provide a rearview reflection of the object and/or individual positioned in front of the second mirror.

20. The system of claim 19, wherein the first mirror is configured at an angle.
